(19) United States
(12) Patent Application Publication
(10) Pub. No.: US 2026/0135825 A1
(43) Pub. Date: May 14, 2026

(54) AI AGENT ECOSYSTEM AND CREATION PLATFORM

(71) Applicant: META PLATFORMS, INC., Menlo Park, CA (US)

(72) Inventors: Hannah Lea Cassius, Kirkland, WA (US); Huihui Fan, New York, NY (US); Benjamin Thomas Loulier, San Francisco, CA (US); Demi Douglas, Los Angeles, CA (US); Gabriella Schwarz, New York, NY (US); George Orlin, Marietta, GA (US); Giovanni Carlo Mayuga Alcantara, Los Angeles, CA (US); Giuliano Morse, San Francisco, CA (US); Matthew Ryan Gabor, Altadena, CA (US); Yash Agarwal, San Francisco, CA (US); Wiqas Tahir, McLean, VA (US); Maheen Sohail, Brooklyn, NY (US); Saeed Jahed, Seattle, WA (US); Marlena Lorraine Morshead, Los Angeles, CA (US); Merlyn Deng, Bellevue, WA (US); Eric Desfosses, Los Altos, CA (US); Zakariya Ahmad, Berkeley, CA (US); Adam Kelsey, Hoboken, NJ (US); Alison Azera, Santa Monica, CA (US); Laycee Berkas, Fremont, CA (US); Sabrina Ylan Vogeley, Redwood City, CA (US)

(21) Appl. No.: 18/945,352

(22) Filed: Nov. 12, 2024

(51) Int. Cl. H04L 51/02; G06N 20/00

(52) U.S. Cl. CPC H04L 51/02; G06N 20/00

(57) ABSTRACT

The present application at least describes a system and a method for creating an artificial intelligence (AI) chatbot. The method may include a step of causing to display, via a user interface of a web-based platform, a prompt to create the AI chatbot. The prompt may include a description of services and functions associated with the AI chatbot. The method may also include a step of receiving, via the user interface from a user of the web-based platform, a selection of any one or more of the description of services or functions associated with the AI chatbot. The method may further include a step of training, based on the received input and data associated with the user available on the web-based platform, a machine learning (ML) model associated with the AI chatbot. The method may even further include a step of configuring the created AI chatbot with the trained ML model. The method may yet even further include a step of displaying, via the user interface of the web-based platform, the configured AI chatbot capable of communicating in real-time with the user or an additional user of the web-based platform.

### TECHNOLOGICAL FIELD

Examples of the present disclosure may relate generally to methods, systems and computer program products for a platform that enables a user to create and deploy artificial intelligent agents.

### BACKGROUND

Electronic devices are constantly evolving to provide users with more flexibility and adaptability. With increasing adaptability in electronic devices, users are maintaining their devices in close proximity during various everyday activities. The adaptability of electronic devices may lead to users seeking to improve their experience with web-based platforms (e.g., applications) operating on their electronic devices. For instance, users may wish to improve or add to the adaptability of platforms to enhance their experience or introduce ideas to other users. Additionally, users may wish to employ user friendly AI tools offering the capability to create content expressing their imagination.

One such area where creative control may be desired is in the field of chatbots (e.g., AI bot or AI agent). Chatbots may be employed on web-based platforms to communicate with users in real-time. However needs exist in the field to improve the quality of a chatbot's communication.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the disclosed subject matter; however, the disclosed subject matter is not limited to the specific methods, compositions, and devices disclosed. In addition, the drawings are not necessarily drawn to scale. In the drawings:

FIG. 1A illustrates an example system in accordance with an example of the present disclosure.

FIG. 1B illustrates a diagram of an exemplary communication device in accordance with one or more example aspects of the subject technology.

FIG. 1C illustrates an exemplary computing system in accordance with one or more example aspects of the subject technology.

FIG. 1D illustrates a machine learning and training model framework in accordance with an aspect of the subject technology.

FIG. 2A illustrates an example chatbot creation screen in accordance with an aspect of the subject technology.

FIG. 2B illustrates an example instructional screen associated with chatbot creation in accordance with an aspect of the subject technology.

FIG. 2Ci and 2Cii illustrate example chatbot search (e.g., browse) screens in accordance with an aspect of the subject technology.

FIG. 2Di, 2Dii and 2Diii illustrate example randomized chatbot templates in accordance with an aspect of the subject technology.

FIG. 3A illustrates chatbot settings optimization functionality (e.g., adjustment) on a user interface in accordance with an aspect of the subject technology.

FIG. 3Bi, 3Bii and 3Biii illustrate chatbot advanced settings optimization functionality (e.g., adjustment) on a user interface in accordance with an aspect of the subject technology.

FIG. 3Ci and 3Cii illustrate chatbot sharing functionality on a user interface in accordance with an aspect of the subject technology.

FIG. 4Ai and 4Aii illustrate a review notification in association with a chatbot on a user interface in accordance with an aspect of the subject technology.

FIG. 4Bi, 4Bii and 4Biii illustrate an approval notification in association with a chatbot on a user interface in accordance with an aspect of the subject technology.

FIG. 4Ci, 4Cii, 4Ciii and 4Civ illustrate a rejection notification in association with a chatbot on a user interface in accordance with an aspect of the subject technology.

FIGS. 5A, 5B and 5C illustrate chatbot optimization functionality on a user interface in accordance with an aspect of the subject technology.

FIG. 6 illustrates a flow chart of an example embodiment in accordance with an aspect of the subject technology.

FIG. 7 illustrates a flow chart of another example embodiment in accordance with an aspect of the subject technology.

The figures depict various examples for purposes of illustration only. One skilled in the art will readily recognize from the following discussion that alternative examples of the structures and methods illustrated herein may be employed without departing from the principles described herein.

### BRIEF SUMMARY

Disclosed herein are methods, systems, and computer program products configured to develop and deploy artificially intelligent chatbots (e.g., AI agents or AI bots).

One aspect of the application is directed to a method of creating an AI chatbot. The method may include a step of causing to display, via a user interface of a web-based platform, a prompt to create to AI chatbot. The prompt may include a description of services and functions associated with the AI chatbot. The method may also include a step of receiving, via the user interface from a user of the web-based platform, a selection of any one or more of the description of services or functions associated with the AI chatbot. The method may further include a step of training, based on the received input and data associated with the user available on the web-based platform, a machine learning (ML) model associated with the AI chatbot. The method may even further include a step of configuring the created AI chatbot with the trained ML model. The method may yet even further include a step of displaying, via the user interface of the web-based platform, the configured AI chatbot capable of communicating in real-time with the user or an additional user of the web-based platform.

Another aspect of the application is directed to a method of deploying the AI chatbot. The method may include a step of receiving, via a user interface of a web-based platform configured with the AI chatbot, a communication from a user or an additional user on the platform. The method may also include a step of reviewing, via the AI chatbot, the received communication from the user or the additional user. The AI chatbot may include a trained machine learning (ML) model trained on any one or more of a description of services or functions of the AI chatbot selected by the user or data associated with the user on the web-based platform. The method may further include a step of generating, via the trained ML model of the AI chatbot, a message in response to the received communication. The method may even further include a step of causing to display, via the user interface of the web-based platform, the generated message as a reply from the AI chatbot to the received communication.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### DETAILED DESCRIPTION

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” (app) may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

Disclosed herein are methods, systems and computer program products that provide a web-based platform in which user input (e.g., text, image, video, or the like, or any combination thereof) is utilized to create (e.g., generate) and subsequently deploy an AI chatbot. The subject technology provides solutions to current technical problems in the art in the field of machine learning. Namely trained machine learning models based on data disclosed herein are integrally associated with AI chatbots. In turn, the AI chatbots seamlessly communicate with one or more users via an interface of a web-based platform appearing on a display of an electronic device. As a result, these chatbots are configured to reliably and accurately convey information on behalf of a user to one or more other users of a web-based platform in real-time.

In an aspect of the subject technology, a web-based platform may be configured to store, receive or collect information associated with a user profile. The chatbot created (e.g., generated) may be customizable or tunable based on user preference. The chatbot created (e.g., generated) may be optimizable based on user (e.g., creator input). The chatbot created (e.g., generated) may be utilized by one or more users of a plurality of users associated with the platform. The chatbot may be associated with a machine learning system capable of providing content items, such as but not limited to, text, audio, image, video, or the like, or any combination thereof in response to a user input. The machine learning system may employ one or more large language models (LLMS) or machine learning models to create (e.g., generate) the chatbot. The machine learning system may be configured to determine a result based on a user input. The platform as disclosed herein may allow for an average user (e.g., a user with not technical background or knowledge of machine learning systems) to create, tune, and implement a chatbot to foster creative control of chatbots. The chatbot created (e.g., generated) may be utilized for any suitable function determined by the creator (e.g., user), such as but not limited to communication, entertainment, expression, or the like, or any combination thereof. The term “creator” as referred to herein may refer to a user associated with a platform that may have used the platform to generate (e.g., create) a chatbot.

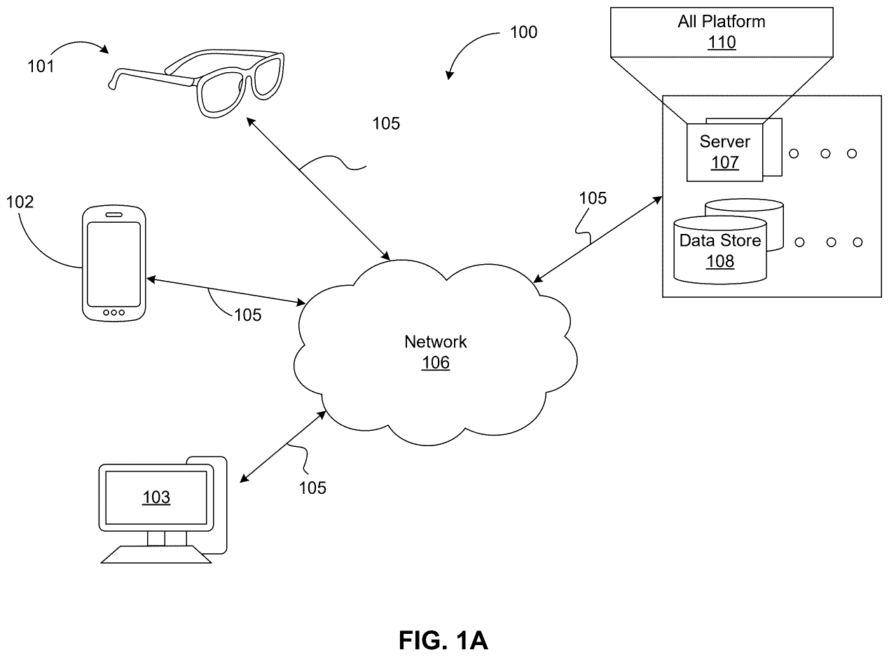

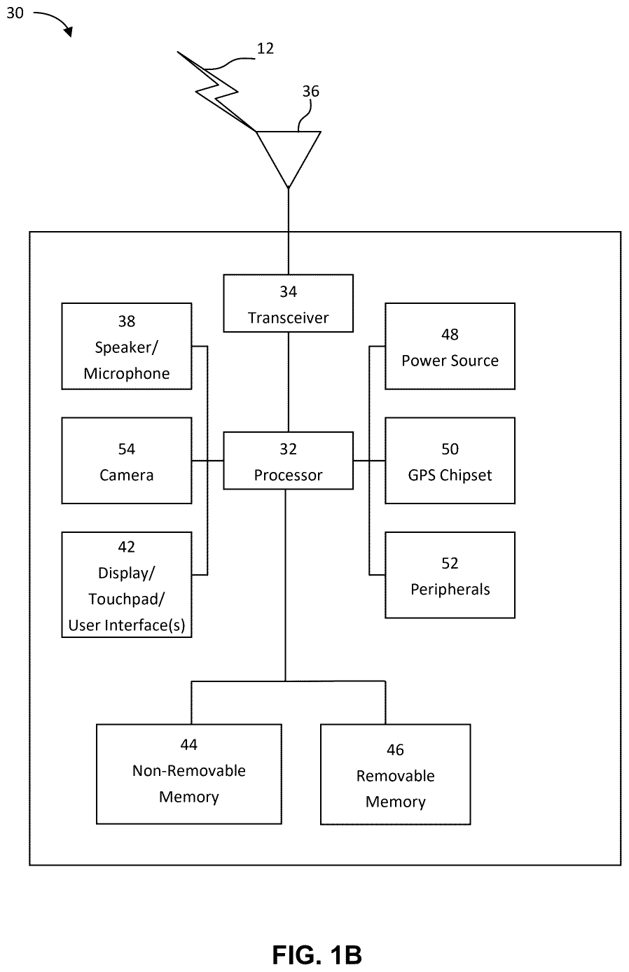

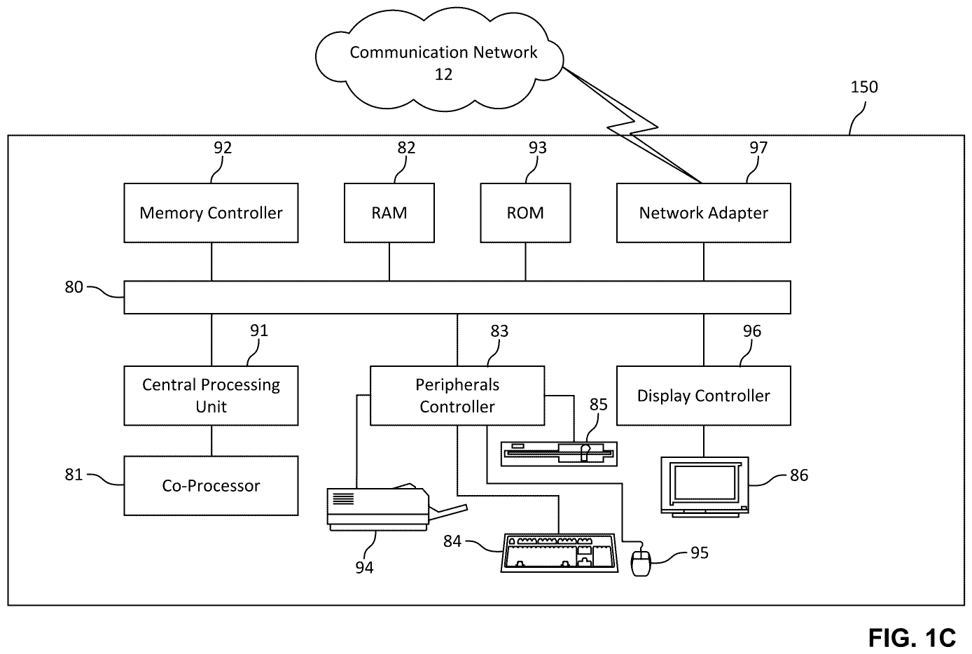

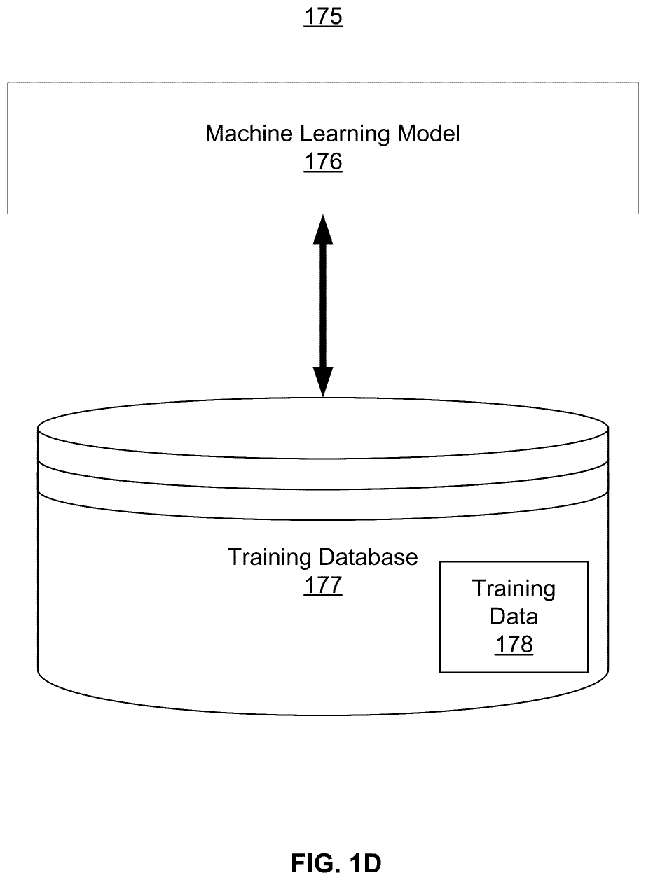

FIG. 1A illustrates an example system 100 that may implement a platform 110. The system 100 may be capable of facilitating communications among users or provisioning of content among users. System 100 may include one or more communication devices 101, 102, and 103 (also may be referred to as user devices), server 107, data store 108, or platform 110. As shown for simplicity, platform 110 may be located on server 107. It is contemplated that platform 110 may be located on or interact with one or more devices of system 100. It is contemplated that platform 110 may be a feature or native component of a third-party platform or device (e.g., device 101, 102, 103). Additionally, system 100 may include any suitable network, such as, for example, network 106.

In an example, device 101, device 102, and device 103 may be associated with an individual (e.g., a user) that may interact or communicate with platform 110. platform 110 may be considered, or associated with, an application, a messaging platform, a social media platform, or the like, or any combination thereof. In some examples, one or more users may use one or more devices (e.g., device 101, 102, 103) to access, send data to, or receive data from platform 110 which may be located on server 107, device (e.g., device 101, 102, 103), or the like.

This disclosure contemplates any suitable network 106. As an example and not by way of limitation, one or more portions of network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. In some examples, network 106 may include one or more networks 106.

Devices 101, 102, 103 may be an electronic device including hardware, software, or embedded logic components or a combination of two or more such components and capable of carrying out the appropriate functionalities implemented or supported by the devices 101, 102, 103. As an example and not by way of limitation, devices 101, 102, 103 may be a computer system such as for example, a desktop computer, notebook or laptop computer, netbook, a tablet computer (e.g., smart tablet), e-book reader, global positioning system (GPS) device, personal digital assistant (PDA), handheld electronic device, cellular telephone, smartphone, augmented/virtual reality device, other suitable electronic device, or any suitable combination thereof. This disclosure contemplates any suitable device(s) (e.g., devices 101, 102, 103). One or more of the devices 101, 102, 103 may enable a user to access network 106. One or more of the devices 101, 102, 103 may enable a user(s) to communicate with other users at other devices 101, 102, 103.

In particular examples, system 100 may include one or more servers 107. Each of the servers 107 may be a unitary server or a distributed server spanning multiple computers or multiple datacenters. Servers 107 may be of various types, such as, for example and without limitation, web server, news server, mail server, message server, advertising server, file server, application server, exchange server, database server, proxy server, another server suitable for performing functions or processes described herein, or any combination thereof. In particular examples, each of the servers 107 may include hardware, software, or embedded logic components or a combination of two or more such components for carrying out the appropriate functionalities implemented or supported by server 107.

In particular examples, system 100 may include one or more data stores 108. Data stores 108 may be used to store various types of information. In particular examples, the information stored in data stores 108 may be organized according to specific data structures. In particular examples, each of the data stores 108 may be a relational, columnar, correlation, or other suitable database. Although this disclosure describes or illustrates particular types of databases, this disclosure contemplates any suitable types of databases. Particular examples may provide interfaces that enable devices 101, 102, 103 or another system (e.g., a third-party system) to manage, retrieve, modify, add, or delete, the information stored in data store 108.

In particular examples, platform 110 may be a network-addressable computing system that may host an online messaging platform. Platform 110 may generate, store, receive, or send user information (also referred herein as user data) associated with a user, such as, for example, user-profile data (e.g., user online presence), geographical location, previous searches, interactions with content, or other suitable data related to the platform 110. Platform 110 may be accessed by one or more components of system 100 directly and/or via network 106. As an example and not by way of limitation, device 101 may access platform 110 located on server 107 by using a web browser, feature of a third-party platform (e.g., function of a social media application, function of a AR application), or a native application on device 101 associated with platform 110 (e.g., a messaging application, a social media application, another suitable application, or any combination thereof) directly or via network 106.

In particular examples, platform 110 may store one or more user profiles associated with an online presence in one or more data stores 108. In particular examples, a user profile may include multiple nodes—which may include multiple user nodes (each corresponding to a particular user associated with a device 101, device 102, or device 103) or multiple concept nodes (each corresponding to a particular role or concept)—and multiple edges connecting the nodes. Users of the platform 110 may have the ability to communicate and interact with other users or chatbots created by other users. In particular examples, users associated with a particular device (e.g., device 101) may join the platform 110 and then add connections (e.g., relationships) to a number of other users (e.g., device 102, 103) constituting contacts or connections of platform 110 to whom they want to communicate with or be connected with. For example, the one or more connections to the user profile may comprise a first friend of a plurality of friends associated with a list of friends.

In some examples, user connections or communications may be monitored for machine learning purposes. In an example, server 107 of platform 110 may receive, record, or otherwise obtain information associated with the connections of users (e.g., device 101, device 102, or device 103). As such, the monitored connections may be utilized for determining trends related to a user profile or one or more connections associated with the user profile. In some examples, user communications with a chatbot may be monitored for machine learning purposes. In an example, server 107 of platform 110 may receive, record, or otherwise obtain information associated with the communications between a user (e.g., device 101, device 102, or device 103) and a chatbot. As such, the monitored communications may be utilizing for adjusting (e.g., tuning) the chatbot, or determining trends related to a user profile and other chatbots of a plurality of chatbots (e.g., one or more chatbots created by one or more users associated with the platform 110).

In particular examples, platform 110 may provide users with the ability to take actions on various types of items. As an example, and not by way of limitation, the items may include groups to which a user may belong, messaging boards in which a user might be interested, question forums, interactions with images, stories, videos, comments under a post, or other suitable items. A user may interact with anything that is capable of being represented in platform 110. In particular examples, platform 110 may be capable of linking a variety of users. As an example, and not by way of limitation, platform 110 may enable users to interact with each other as well as receive media (e.g., video, audio, text, or the like, or any combination thereof) from their respective group (e.g., associated with a number of connections), wherein the group may refer to a chosen plurality of users that may be communicating or interacting through application programming interfaces (API) or other communication channels to each other

In some examples, a device (e.g., device 101, 102, 103) associated with a user may perform the methods as disclosed herein with a chatbot as a second user, wherein the chatbot (e.g., AI bot) may foster communication and provide a content item (e.g., video, audio, text, or the like, or any combination thereof) referenced, fetched, or created (e.g., generated) based on a input associated with a user, wherein a machine learning model may fetch, reference, or create (e.g., generate) a content item associated with the input. In some examples, the chatbot may respond to the user with a result comprising the content item associated or related to the received input. The user and the chat bot may continue to foster communication and further develop ideas or reference information on the device (e.g., device 101, 102, 103) associated with the user. In some examples, the chatbot may be customizable, wherein the chatbot may learn how to provide a result based on a user input or setting associated with the creator of the chatbot. In some examples, the chatbot may learn, via a machine learning model, where a user profile associated with the user may be utilized to aid the AI bot in responding to the received input associated with the user.

Although FIG. 1A illustrates a particular arrangement of device 101, 102, 103, network 106, server 107, data store 108, or platform 110, among other things, this disclosure contemplates any suitable arrangement. The devices of system 100 may be physically or logically co-located with each other in whole or in part.

FIG. 1B illustrates a block diagram of an exemplary hardware/software architecture of a communication device such as, for example, user equipment (UE) 30. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 1B, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items of a web-based platform and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

FIG. 1C is a block diagram of an exemplary computing system 150. In some exemplary embodiments, the network device 160 may be a computing system 150. The computing system 150 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

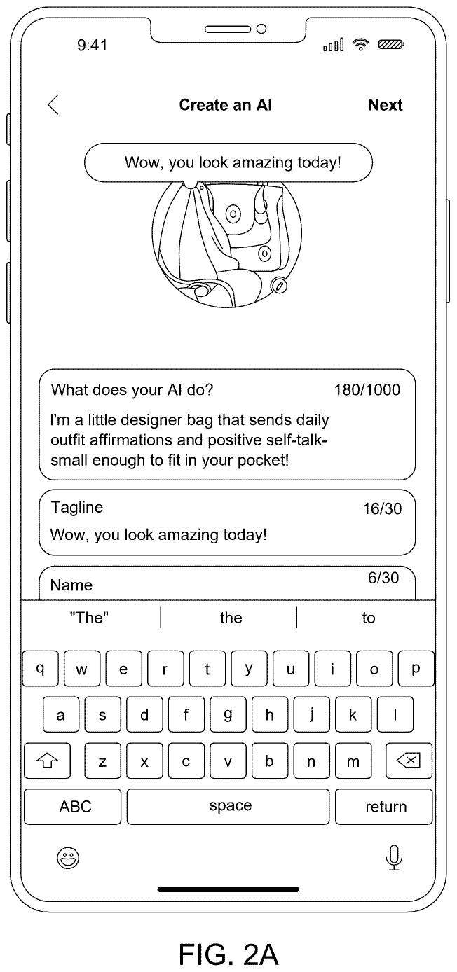

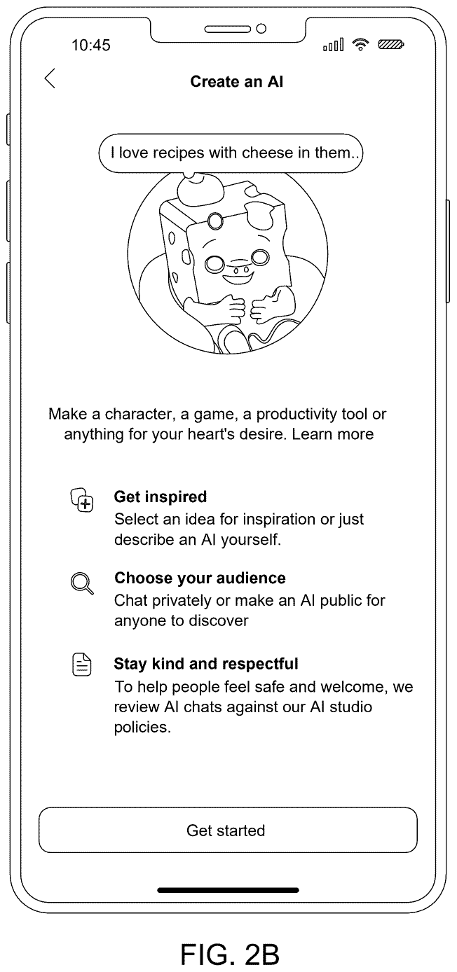

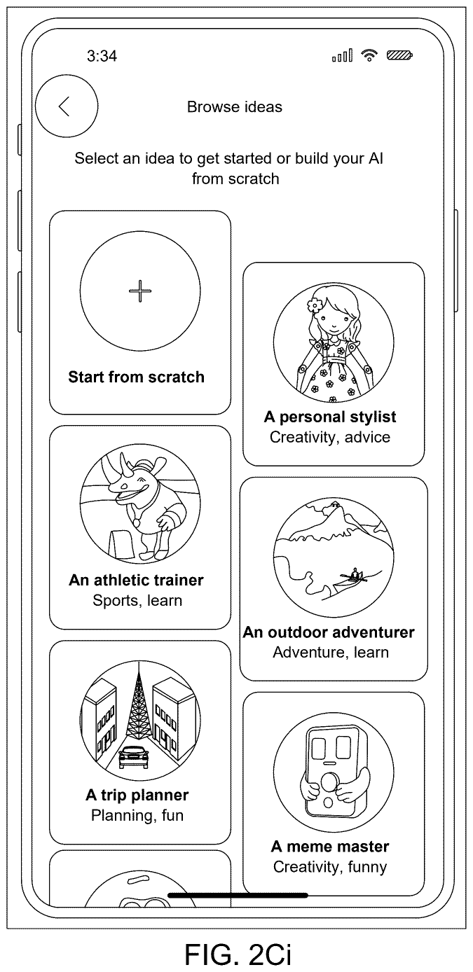

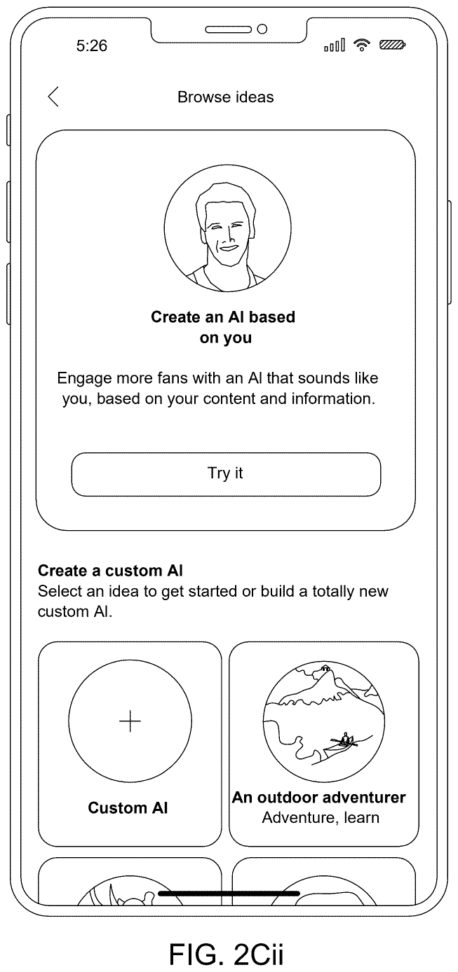

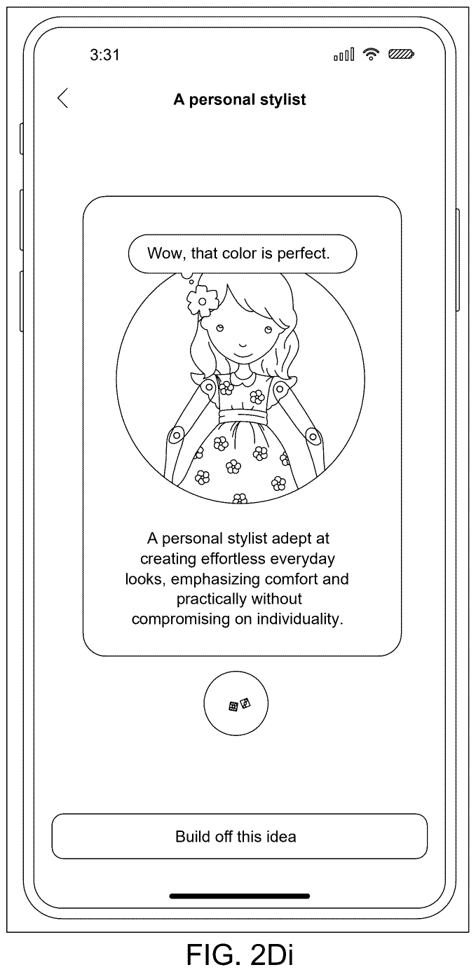

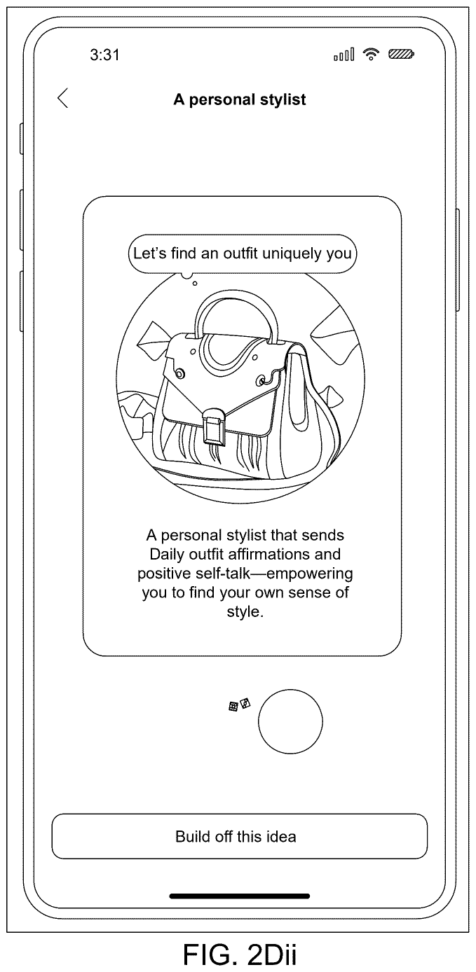

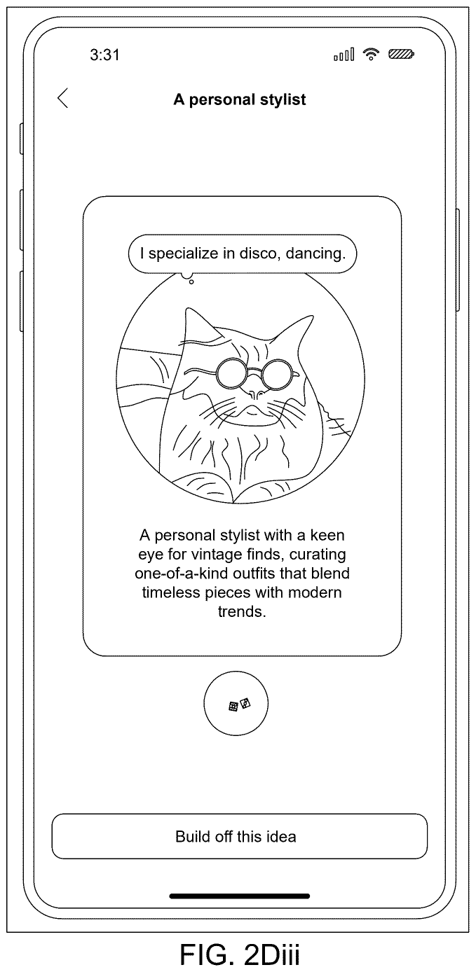

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items of a web-based platform as will be described in more detail with respect to FIGS. 2-5, and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 150 may contain communication circuitry, such as for example a network adapter 97, that may be used to connect computing system 150 to an external communications network, such as network 12 of FIG. 1B, to enable the computing system 150 to communicate with other nodes (e.g., UE 30) of the network.

FIG. 1D illustrates a machine learning and training model, in accordance with an example of the present disclosure. The machine learning framework 175 associated with the machine learning model may be hosted remotely. Alternatively, the machine learning framework 175 may reside within a server 107 shown in FIG. 1A, or be processed by an electronic device (e.g., head mounted displays, smartphones, tablets, smartwatches, or any electronic device, such as communication device 105). The machine learning model 176 may be communicatively coupled to the stored training data 178 in a memory or database (e.g., ROM, RAM) such as training database 177. In some examples, the machine learning model 176 may be associated with operations of any one or more of the systems/architectures depicted in subsequent figures of the application. In some other examples, the machine learning model 176 may be associated with other operations. The machine learning model 176 may be implemented by one or more machine learning models(s) and/or another device (e.g., a server and/or a computing system). In some embodiments, the machine learning model 176 may be a student model trained by a teacher model, and the teacher model may be included in the training database 177.

### Web-Based Platform

According to an example aspect of the subject technology, FIG. 2A illustrates an example chatbot creation user interface (e.g., screen). The user interface may be associated with a web-based platform. In an example embodiment, the web-based platform may be a social platform. The user interface may provide a user with the ability to enter details about the chatbot.

In an embodiment of this aspect, a home screen may include specific elements associated with a chatbot, such as but not limited to, a search function, a list of popular chatbots, a plurality of chatbot templates, or any other suitable feature. The search function may allow a user to provide to an input (e.g., text, audio, or the like) to reference (e.g., search) a database (e.g., data store 108) comprising a plurality of chatbots that have been created previously (e.g., chatbots created by one or more users of a plurality of users, or predicted chatbot templates generated by platform 110). In response to the input associated with the search function a user may be provided with one or more chatbots of a plurality of chatbots that may be related or associated with the input (e.g., context of the input). The plurality of chatbots may be created (e.g., generated) by one or more users of a plurality of users associated with the platform 110. The list of popular chatbots may be a list of one or more chatbots of the plurality of chatbots, wherein the list of one or more chatbots may be associated with chatbots that have had more interactions (e.g., more users, more clicks, more likes, or the like) with one or more users of a plurality of users associated with the platform 110.

In some examples, the graphical user interface may also provide a plurality of chatbot templates on the home screen. The plurality of chatbot templates may comprise a number of predicted chatbots. The number of chatbots may be predicted (e.g., created) via a machine learning model based on trends associated with a user (e.g., user clicks on a post, user interactions with content items of the platform, or any other suitable data) associated with the platform 110. One or more of the chatbots may be generated (e.g., developed or created) via a machine learning model of the platform 110.

In an embodiment, when the user selects an existing chatbot as its template, a subsequent user interface may appear for customization of the chatbot's profile. This information may include, but is not limited to, details of a creator, AI training, sharing capabilities of the chatbot, reporting of the chatbot, editing the chatbot, searching the chatbot, navigation back to the search function, or any other suitable information thereof.

According to another embodiment of this aspect, the user may select an image for the chatbot during the creation phase. The user may also input a description to a query (e.g., “What does your AI do?”) displayed on the user interface 200 depicted in FIG. 2A. The input from the user as depicted in FIG. 2A may indicate, for example, “I'm a little designer bad that sends daily outfit affirmations and positive self-talk small enough to fit in your pocket!”

Further, the user may be provided a tagline section prompting the user to input a tagline. The tagline may be an introduction to the chatbot that another user of the plurality of users may see when interacting with the chatbot created (e.g., generated). For instance, the tagline may read, “Wow, you look amazing today!” The tagline may appear in close proximity to an image associated with the chatbot as depicted in FIG. 2A.

It is contemplated to one of ordinary skill in the art that a user may be directed to the create the chatbot appearing on the user interface of the web-based platform via any suitable method, such as but not limited to, a button associated with a graphical user interface, a button on a user profile, a button on a messaging screen, or any other suitable method. The creation screen may provide a user with examples of the types of chatbots they may be able to create via platform 110 (e.g., as illustrated in the user interface 250 in FIG. 2B). The user may be provided with a description section, where the user may be prompted to provide a description associated with functions and uses of the chatbot which the user may want to create (e.g., a description of services and/or functions of the chatbot). The description section may be utilized by the platform 110 to initiate training of one or more machine learning models associated with the chatbot to be created. For instance, the user may be provided with a template for inspiration of their to be created chatbot (e.g., Get inspired). The user interface 250 in FIG. 2B also depicts an option for the user to choose their audience. The audience may be no one, some people or everyone.

In an embodiment, the machine learning model may be trained on data associated with user communications, user interests, user posts, and the like to determine speech, language, patterns, or the like associated with the user such that the chatbot may provide one or more responses similar to how a user may respond themselves. The chatbot generated may be utilized by a plurality of users of the platform 110, such that when one or more users of the plurality of users interact with the chatbot, the chatbot will provide one or more responses to the one or more users of the plurality of users in a manner or pattern similar to the creator. For example, a celebrity may choose to create a chatbot based on themselves. One or more users of a plurality of users may be able to interact with the chatbot associated with the celebrity, where the one or more users may interact with the chatbot in a manner similar to how they would chat with the celebrity. In response to receiving inputs (e.g., text, or the like) the chatbot associated with the celebrity may respond in a manner similar to how they may speak or respond to the input received. It is contemplated that the creator may interact with the created (e.g., generated) chatbot such that they may optimize future generated responses to capture more of the personality of the creator.

FIGS. 2Ci and 2Cii illustrate example chatbot creation screens 275 and 280, respectively, in accordance with an example of the present disclosure. The chatbot creation user interfaces 275 and 280 shown in FIGS. 2Ci and 2Cii may provide a user with a number of options including a plurality of predicted chatbot templates and an option to create a chatbot (e.g., start from scratch). The plurality of predicted chatbot templates may be based on an assessment of data associated with the user. The data may include any one or more of user trends, user interests, or posts available on the web-based platform. In so doing, the templates are highly-customizable to a user for the purpose of making the chatbot more lifelike and relatable both to the user and additional users on the web-based platform. In some examples, user data may be monitored and associated with interactions of any content item configured to be presented via platform 110 (e.g., a messaging platform, a social media platform, or the like) to make determinations based on user interest, trends, or the like. For example, if a user's interest determines that the user is a sports fan, the randomized template provide a number of example chatbots associated with sports, such as but not limited to, a sport, a workout, a gym, or the like. If the user selects the randomized template, the user may be able to further customize (e.g., edit or optimize) the randomized template. In examples, the chatbot may be illustrated or provided similar to another user, for example, the chatbot may have a profile photo, a description or bio, or any other suitable information. It is contemplated that all the features of the chatbot may be optimizable or customizable to a users' (e.g., creators') preference. It is contemplated that the plurality of predicated chatbot templates may comprise a plurality of randomized templates, as illustrated in the user interfaces 290, 291 and 292, respectively, in FIGS. 2Di, 2Dii and 2Diii. There may be dice button, as shown in each of the user interfaces 290, 291 and 292, or another activation means to randomize from one template (e.g., person with glasses in user interface 290 in FIG. 2Di) to another (e.g., handbag in user interface 291 in FIG. 2Dii or a cat in user interface 292 in FIG. 2Diii). The plurality of randomized templates may be determined at random or based on user trends. For example, if a user interacts with one or more posts, previously created chatbots, or the like associated with football, the plurality of templates may comprise chatbot templates related to the topic of sports. As an example, the plurality of templates may comprise chatbot templates associated with soccer, basketball, or the like.

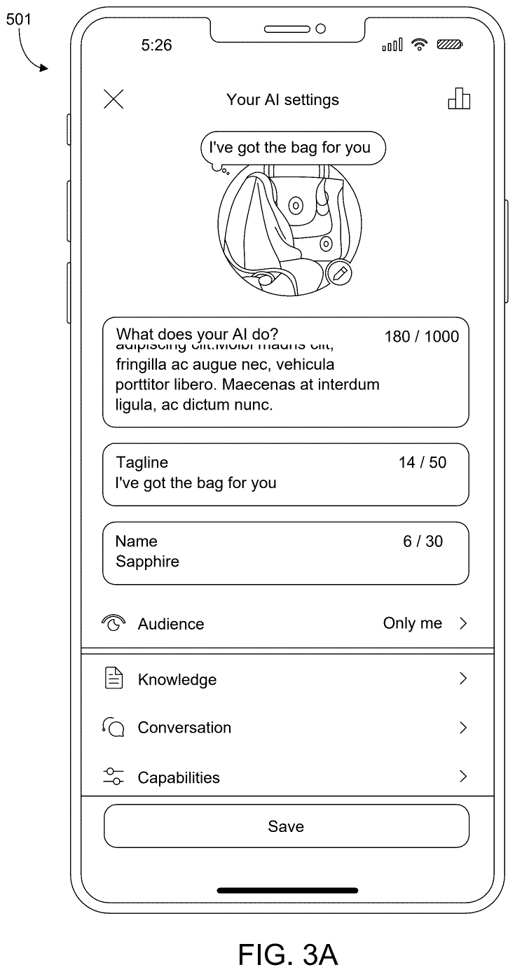

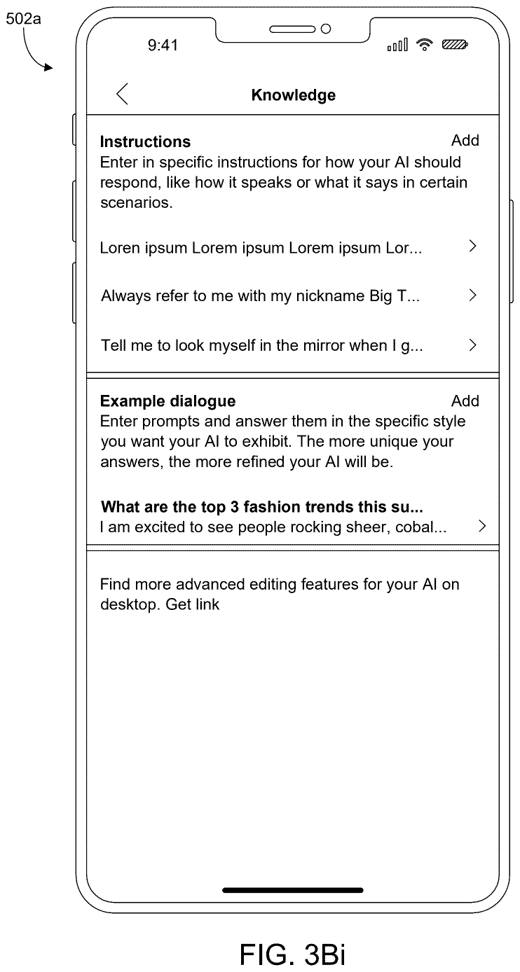

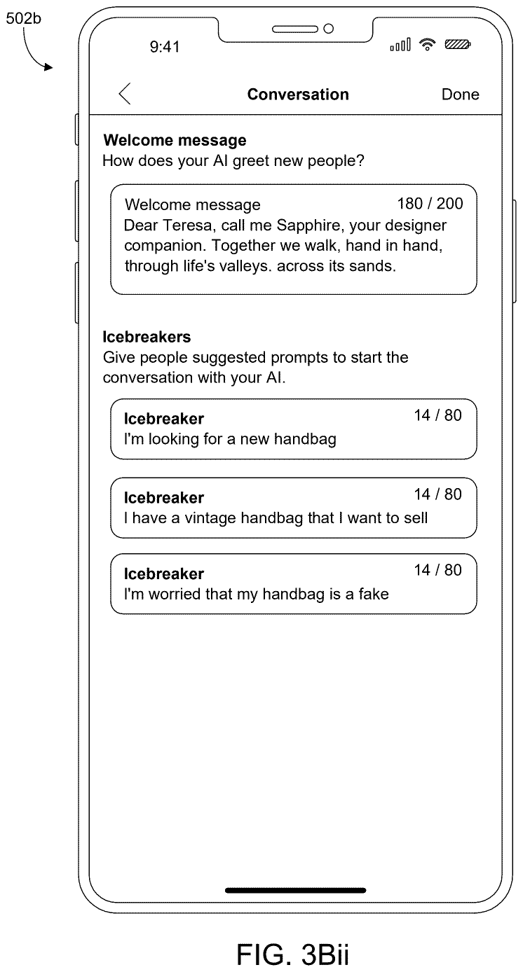

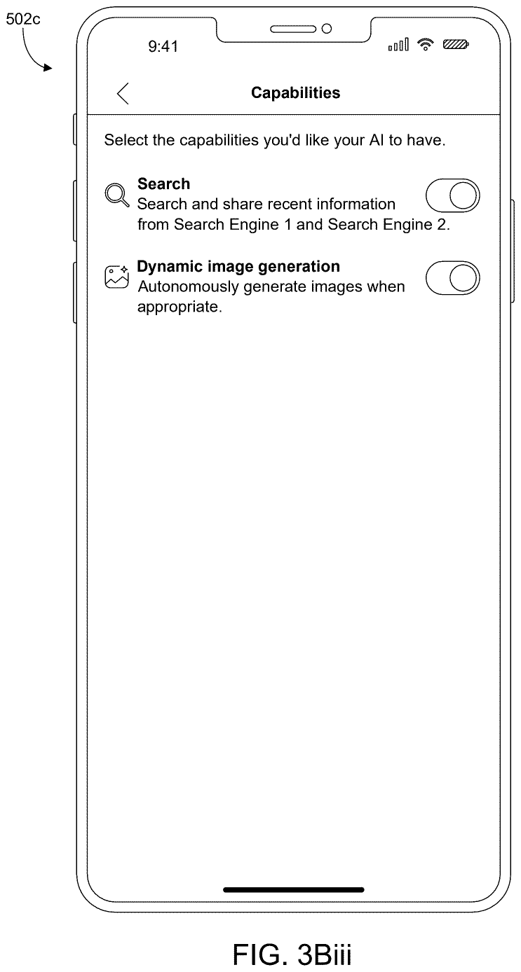

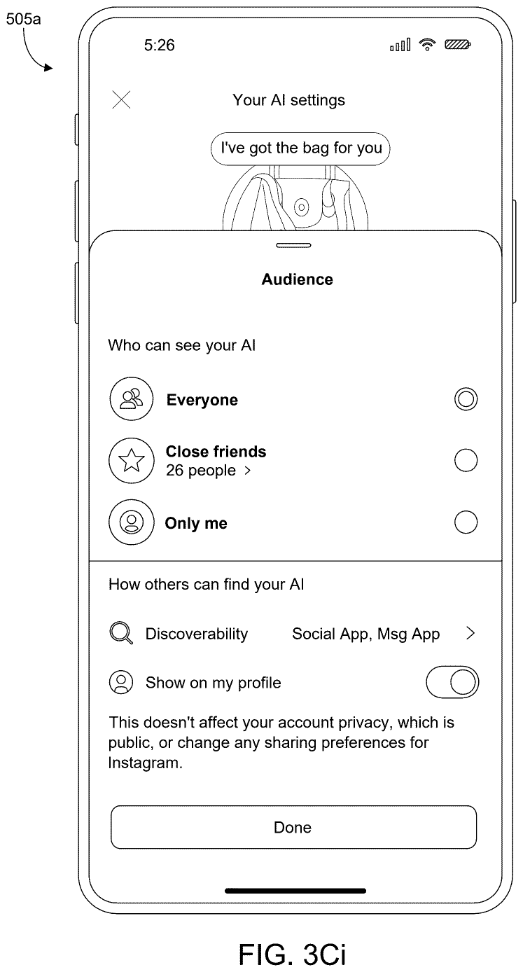

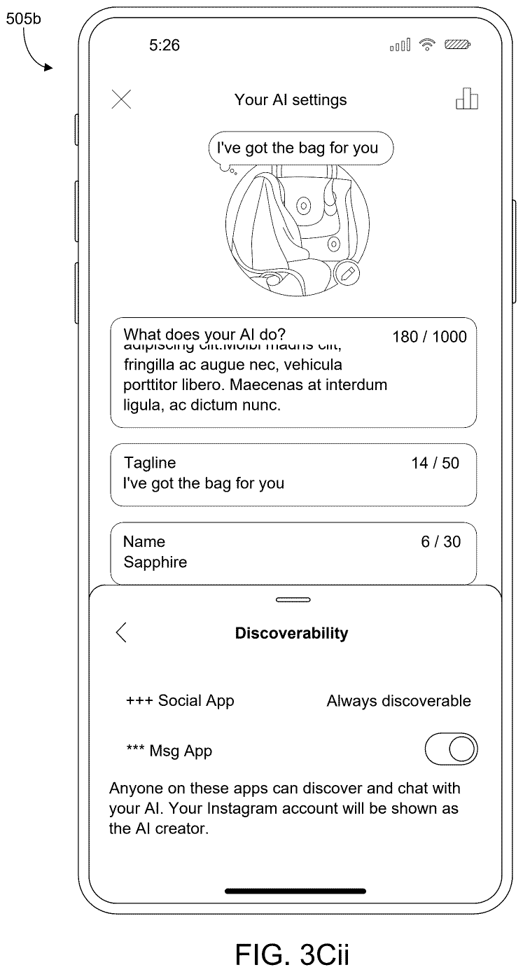

According to another embodiment of this aspect, user interface 300 in FIG. 3A illustrates an example embodiment of chatbot optimization (e.g., settings or adjustment), in accordance with an example of the present disclosure. In an example, the user may be provided a settings user interface (e.g., optimization screen 301). The optimization screen 301 may allow the user to provide information to platform 110 associated with the chatbot. For example, the optimization screen 301 may allow the user to add any suitable information about the chatbot to define and ultimately train the machine learning model associated with the chatbot for communicating with a user (e.g., creator of template) or one or more additional users of the web-based platform. The user may provide, via optimization screen 301, a description, tagline, name, audience, knowledge, conversations capabilities, or the like. In some example embodiments, the platform 110 may be configured to allow a user to access a number of advanced options (e.g., settings) related to the chatbot user interface 325, 326 and 327 respectively illustrated in FIGS. 3Bi, 3Bii and 3Biii. The number of advance options may comprise instructions, example dialogue, icebreakers, capabilities, or the like. The user may be able to adjust and/or edit any of the number of advance options. For example, the user (e.g., creator) may determine a specific language for the chatbot to communicate in. For example, the user may provide an instruction to the chatbot only to respond in a particular vernacular or speech pattern, such as for example, a funny tone, a friendly manner, or any other suitable speech (e.g., text, audio, or the like). The user (e.g., creator) may be able to adjust and provide the plurality of icebreakers that an additional user(s) of the web-based platform may see when interacting with the chatbot created by the user.

According to a further embodiment, user interfaces 350, 351 respectively depicted in FIGS. 3Ci and 3Cii describe chatbot sharing options. It is contemplated to one of ordinary skill in the art that the chatbot may be shared by any suitable method, e.g., a shareable link, a message, or the like. In some examples, the chatbot may be shared from a platform (e.g., platform 110 (e.g., social media platform, messaging platform, or the like)) to another platform (e.g., another social media platform, messaging platform, or the like). For example, a chatbot that was created (e.g., generated) in a first platform may be shared to a second platform. The shared chatbot may be configured to function in the second platform as the chatbot functioned in the first platform. As shown in user interface 350 in FIG. 3Ci, the option for sharing with Everyone is selected. Other options include Close Friends or Only me (e.g., the user). There may also be an option for selecting how others can find the created AI chatbot. Here, the option for the chatbot to appear on the user's profile has been selected.

User interface 351 in FIG. 3Cii depicts an embodiment with options for the chatbot being discovered. In particular, the chatbot may be discovered via a social app and/or a Msg app. As illustrated in user interface 351 in FIG. 3Cii, the Social App option has been set to Always Discoverable, and the Msg app option has been enabled.

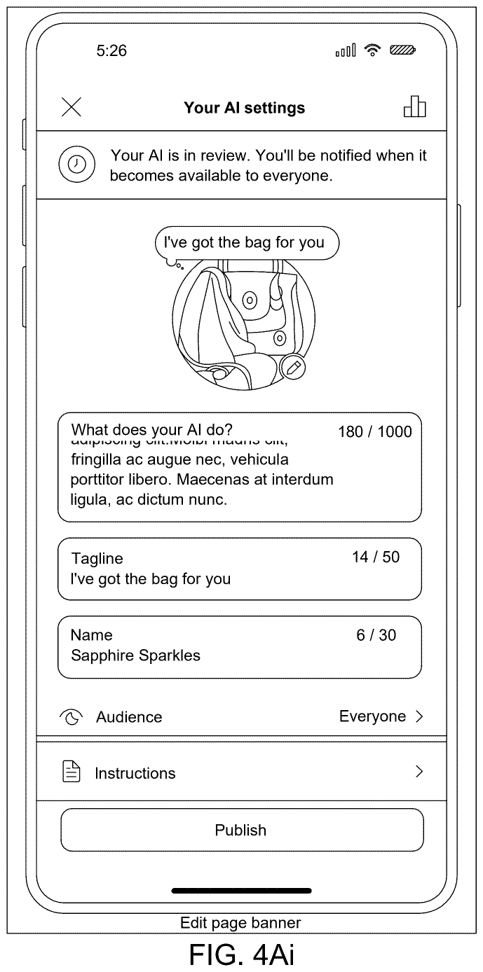

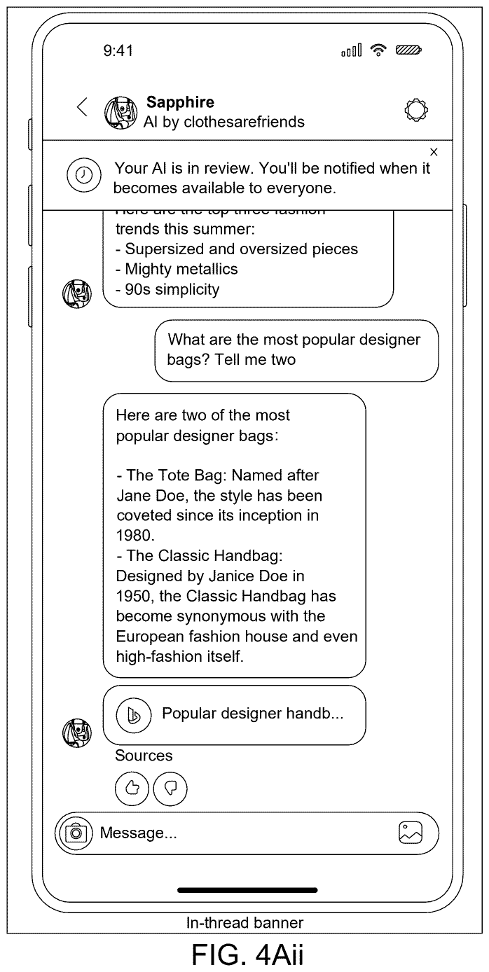

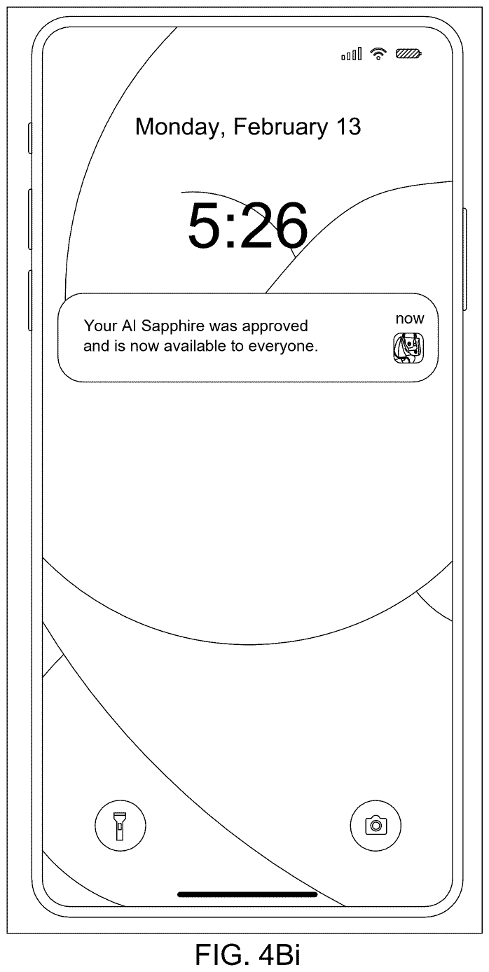

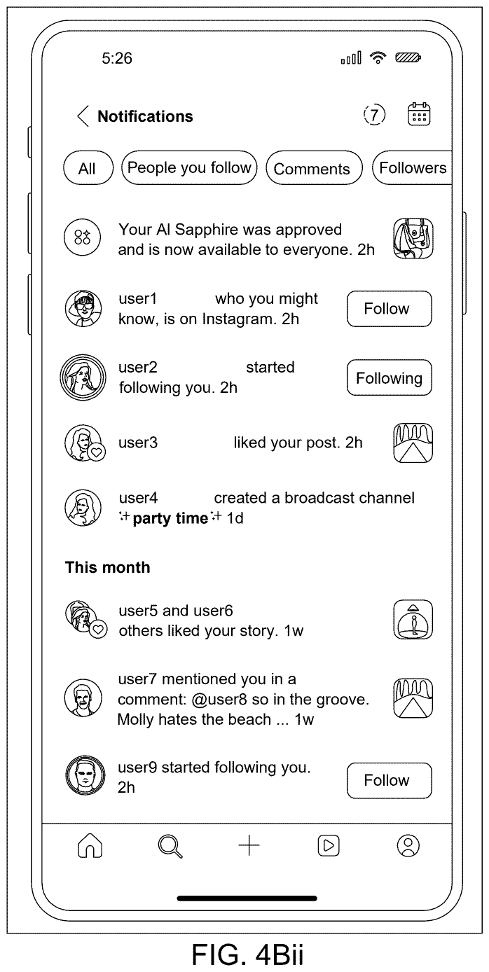

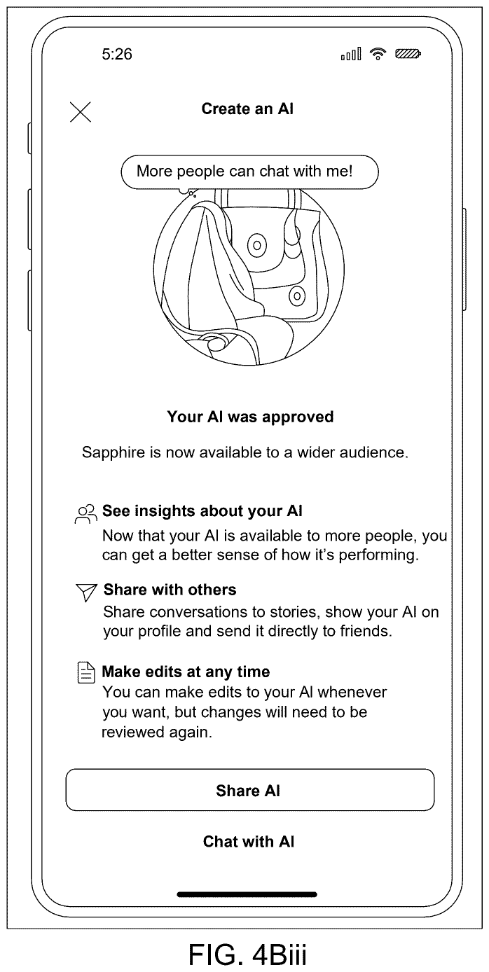

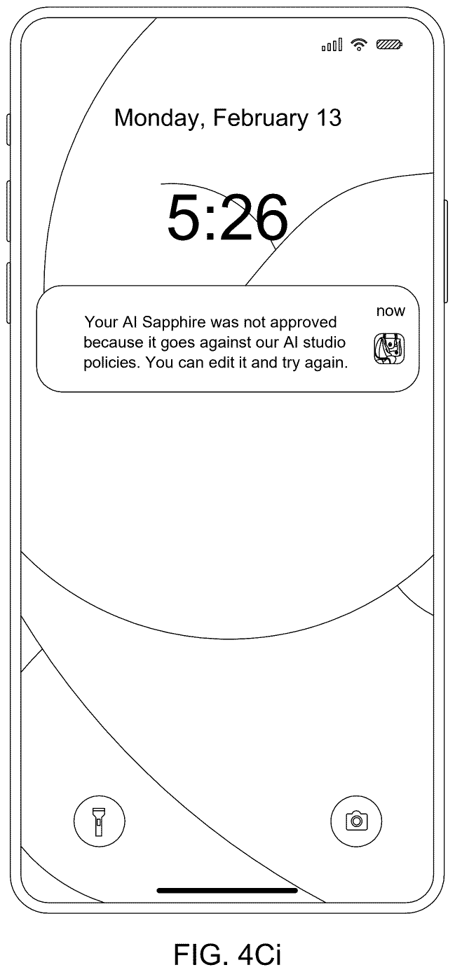

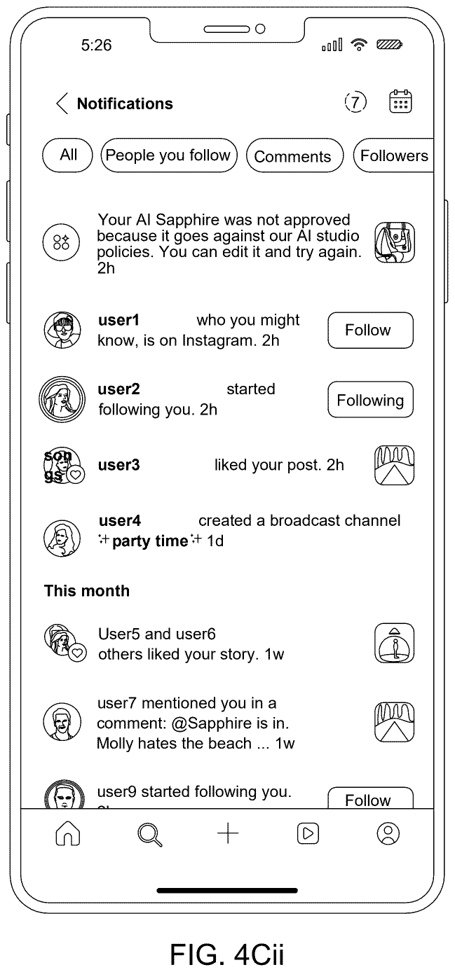

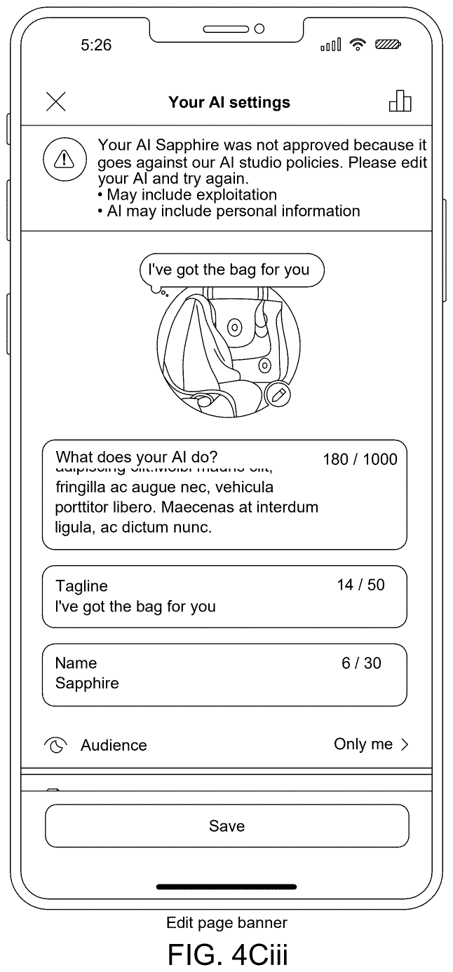

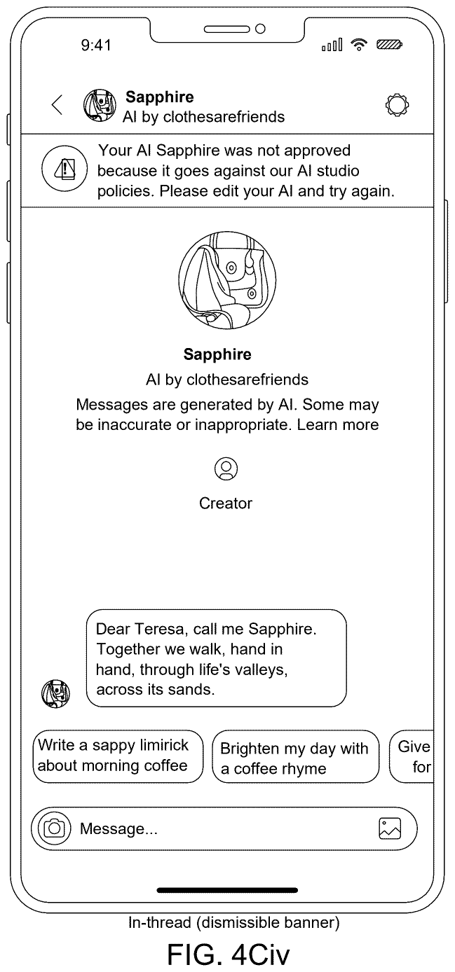

According to even another embodiment of the subject technology, user interfaces 400 and 401 respectively depicted in FIG. 4Ai and 4Aii describe a review notification in association with a chatbot. That is, after a chatbot has been created, the chatbot may be assessed/reviewed prior to being deployed on the user interface of a user. Each of user interfaces 400 and 401 depicts a banner indicating, “Your AI is in review. You'll be notified when it becomes available to everyone.” A review of the created chatbot may be performed by an employee or administrator associated with the web-based platform. The authorization and review process may be based on the chatbot adhering to a set of rules, polices, and procedures associated with the web-based platform (e.g., rules, polices, and procedures associated with an entity that may own or monitor the platform). The review of the created chatbot may result in a notification (e.g., approval notification or rejection notification) being provided to a user (e.g., creator) associated with an approval or denial of the chatbots creation or use on platform 110. The notification (e.g., an approval notification or a rejection notification) may be provided to a user (e.g., creator) via any suitable method, such as but not limited to an text message, banner, push notification, or any other suitable way of communication to a user of platform 110, or any combination thereof.

In an embodiment, the review (e.g., authorization process) of the chatbot, a user (e.g., creator) may receive an approval notification, as illustrated in the user interfaces 425, 426 and 427 respectively shown in FIGS. 4Bi, 4Bii and 4Biii. The approval notification may be received by the creator when the chatbot may be determined to adhere to the set of rules, polices, or procedures of platform 110. As shown in user interface 425 in FIG. 4Bi, a banner may appear in a user's home screen of their device's operating system. It may read, “Your AI Sapphire and is now available to everyone.” As shown in user interface 427 in FIG. 4Biii, the web-based platform may indicate the AI was approved on a user's screen.

In yet a further embodiment, when the chatbot does not adhere to the set of rules, policies, or procedures associated with the platform 110 the user may receive a rejection notification, as illustrated in user interfaces 475, 476, 477 and 478 respectively of FIGS. 4Ci, 4Cii, 4Ciii and 4Civ. For example, a banner may appear in a user's home screen 475 of their device's operating system. It may read, “Your AI Sapphire was not approved because it goes against our AI policies. You can edit it and try again.” User interfaces 477 and 478 may depict a message indicating, “Your AI Sapphire was not approved because it goes against the AI policies. Please edit your AI and try again.” Some of the reasons given may include or be attributed to sensitive information or exploitation information, or the AI including personal information.

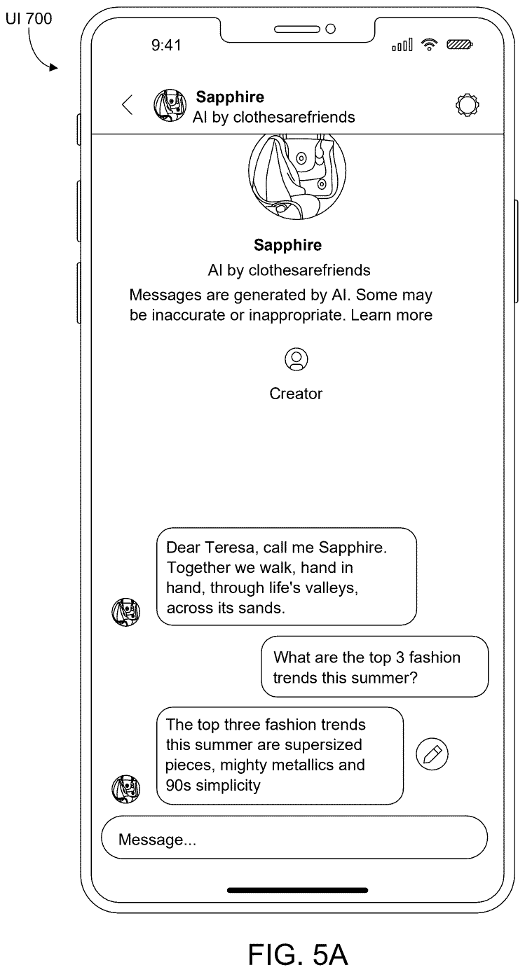

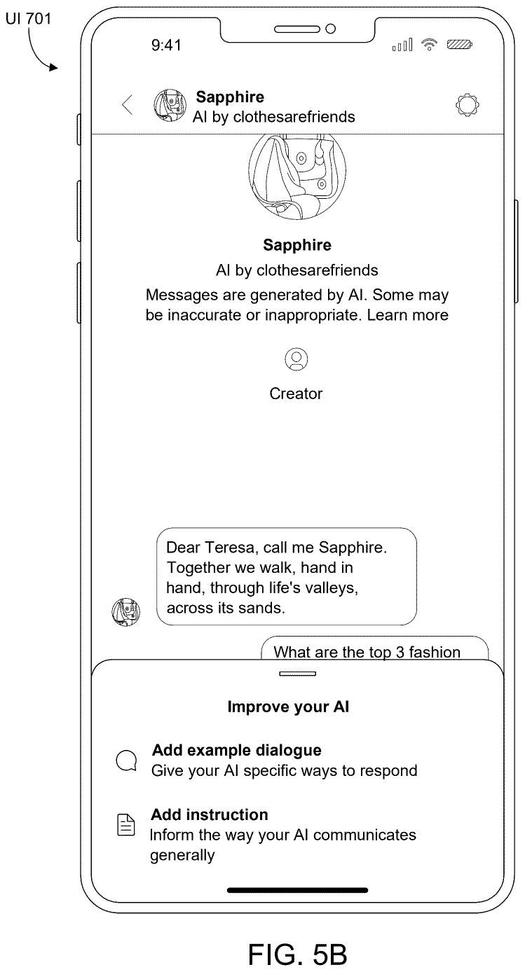

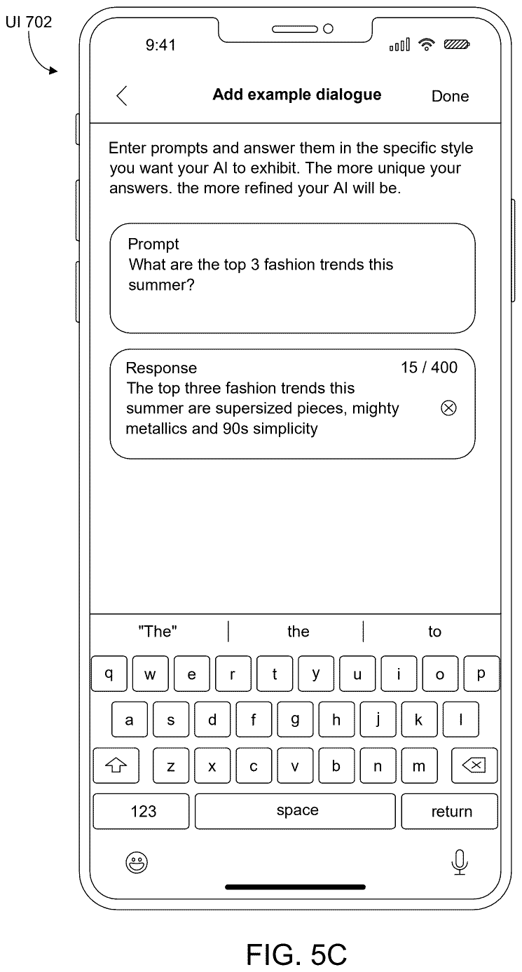

According to yet even a further embodiment, user interfaces 500, 501 and 502, respectively of FIGS. 5A, 5B and 5C illustrate an example optimization of a created (e.g., generated) chatbot, in accordance with an example of the present disclosure. It is contemplated that after the creation of the chatbot, the chatbot may be optimizable (e.g., adjustable) such that the user (e.g., creator) may improve the plurality of results (e.g., one or more responses) generated by the chatbot. In such examples, a user (e.g., creator) may provide one or more predetermined response to one or more specific inputs. For instance, the specific inputs may be provided by the creator (e.g., user). The creator may utilize the one or more predetermined responses to the one or more inputs such that the machine learning model associated with the chatbot may further learn (e.g., be optimized) based on user (e.g., creator preference). In some examples, the creator may create or provide both the one or more predetermined responses and the one or more inputs to an optimization screen associated with the platform. In some examples, a response may be provided by the chatbot and the creator (e.g., user) may be able to edit the response to further optimize or train the machine learning model associated with the chatbot.

The response may be selectable on the graphical user interface 500 of FIG. 5A, which may prompt a user to select among plural options. For instance, the options may include: (i) add example dialogue or add instruction, as illustrated in graphical user interface 501 in FIG. 5B; or (ii) add example dialogue depicted in the graphical user interface 502 in FIG. 5C. The user may now provide (e.g., update) a response to an input (e.g., prompt) such that the provided response may be further utilized to train and optimize the machine learning model of the chatbot created. Updates provided to the response, or the input may further train the machine learning model associated with the chatbot. The updates may improve accuracy and optimization of the responses provided by the chatbot to future inputs associated with a user (e.g., the creator) or one or more users of the plurality of users of platform 110.

In some examples, the platform 110 may be configured to provide the creator (e.g., a user) a method to view or monitor statistics associated with the use of the chatbot. Platform 110 may provide the user with a number of statistical measurements or tabulations such as but not limited to, a total number of unique chats associated with the bot, total number of messages, percentage of positive or negative feedback given as a response, average number of messages sent, or any other suitable measurement.

In some examples, the user interface may provide a visual representation of a number of statistical datapoints associated with usage of the chatbot. For example, the user interface may depict the number of chats over a finite period of time (e.g., last 7 days). The data may also provide an average number of message sends. The user interface may also provide a total number of messages sent and/or received by the chatbot. A feedback rating may also be obtained for the chatbot (e.g., X % positive or negative feedback).

According to yet even a further embodiment, it is envisaged that a chatbot generated (e.g., created) by one or more of the above-mentioned embodiments may be deleted. The deletion may occur at a fixed period of time or may be done ad-hoc. For example, a user (e.g., creator) may delete a chatbot created by the user. As a result, one or more users of the web-based platform may no longer be able to access the chatbot. Users of the web-based platform may receive a prompt or text that may indicate that the chatbot has been deleted or that the chatbot is no longer available. In some examples, one or more users of the plurality of users may receive a prompt or text indicating that the chatbot has been deleted or the chatbot is no longer available in response to the creator (e.g., user) changing the audience associated with the chatbot. For example, if the creator changes the audience from public (e.g., chatbot accessible to the plurality of users) to private (e.g., chatbot accessible to creator or chatbot accessible to friends associated with the creator) a number of users of the plurality of users that do not fit into what the creator may indicate as private will lose access to the chatbot.

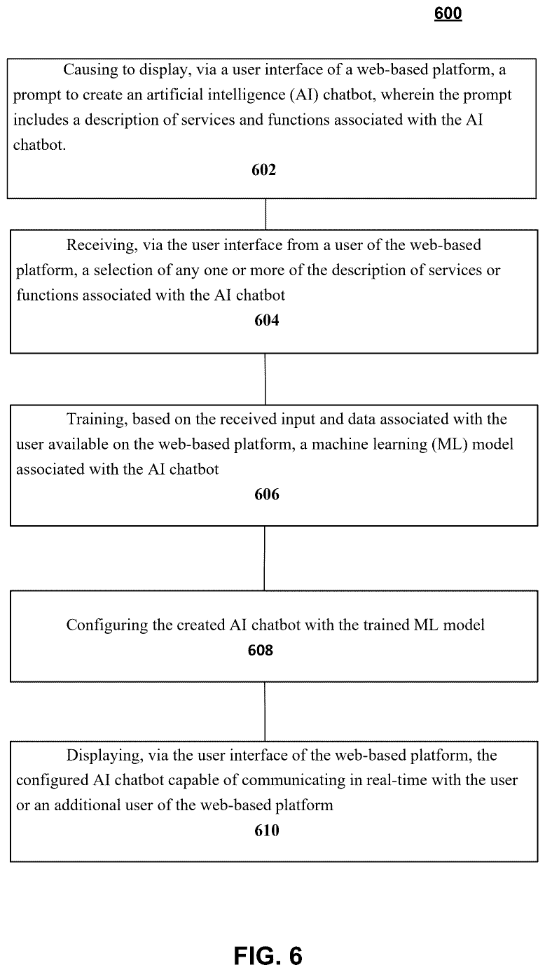

According to yet another embodiment, FIG. 6 depicts a flowchart of an example process 600. In some implementations, one or more process blocks of FIG. 6 may be performed by a device. As shown in FIG. 6, process 600 may include a step of causing to display, via a user interface of a web-based platform, a prompt to create to AI chatbot (block 602). The prompt may include a description of services and functions associated with the AI chatbot As further shown in FIG. 6, process 600 may include a step of receiving, via the user interface from a user of the web-based platform, a selection of any one or more of the description of services or functions associated with the AI chatbot. (block 604). As further shown in FIG. 6, process 600 may include a step of training, based on the received input and data associated with the user available on the web-based platform, ML model associated with the AI chatbot (block 606). As further shown in FIG. 6, process 600 may include a step of configuring the created AI chatbot with the trained ML model (block 608). As further shown in FIG. 6, process 600 may include a step of displaying, via the user interface of the web-based platform, the configured AI chatbot capable of communicating in real-time with the user or an additional user of the web-based platform (block 610).

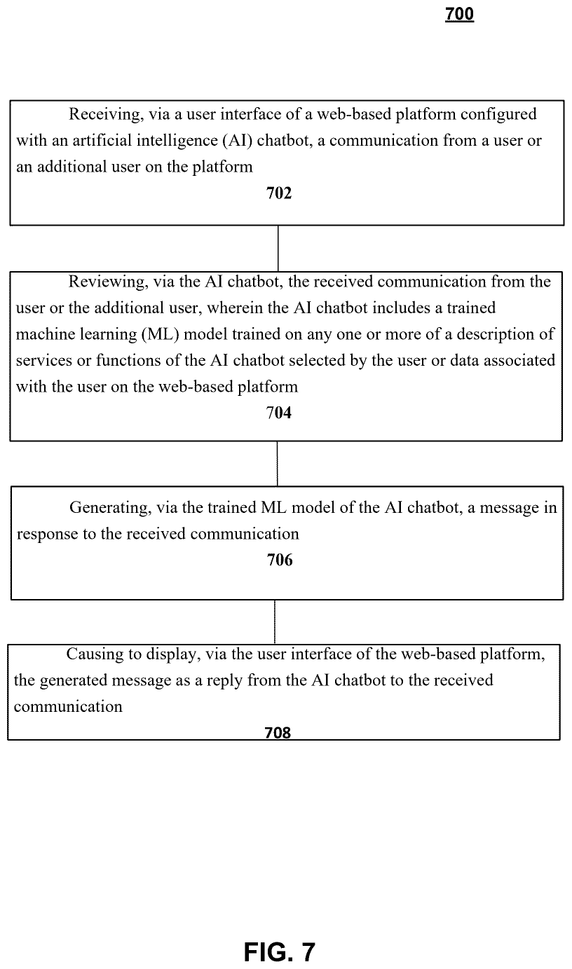

According to yet even another embodiment, FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. As shown in FIG. 7, process 700 may include a step of receiving, via a user interface of a web-based platform configured with the AI chatbot, a communication from a user or an additional user on the platform (block 702). As shown in FIG. 7, process 700 may include a step of reviewing, via the AI chatbot, the received communication from the user or the additional user (block 704). The AI chatbot may include a trained machine learning (ML) model trained on any one or more of a description of services or functions of the AI chatbot selected by the user or data associated with the user on the web-based platform. As shown in FIG. 7, process 700 may include a step of generating, via the trained ML model of the AI chatbot, a message in response to the received communication (block 706). As shown in FIG. 7, process 700 may include a step of causing to display, via the user interface of the web-based platform, the generated message as a reply from the AI chatbot to the received communication.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
causing to display, via a user interface of a web-based platform, a prompt to create an artificial intelligence (AI) chatbot, wherein the prompt comprises a description of services and functions associated with the AI chatbot;
receiving, via the user interface from a user of the web-based platform, a selection of any one or more of the description of services or the functions associated with the AI chatbot;
training, based on the received input and data associated with the user available on the web-based platform, a machine learning (ML) model associated with the AI chatbot;
configuring the created AI chatbot with the trained ML model; and
displaying, via the user interface of the web-based platform, the configured AI chatbot configured to communicate in real-time with the user or an additional user of the web-based platform.

2. The method of claim 1, further comprising:
causing to display, via the user interface of the web-based platform, selectable templates that assist a user to create the AI chatbot; and
receiving, via the user interface from the user of the web-based platform, a selection of one of the templates.

3. The method of claim 2, wherein the displayed templates on the web-based platform are based on an assessment of the data associated with the user.

4. The method of claim 3, wherein the data associated with the user is selected from any one or more of trends, posts or interests located on the web-based platform.

5. The method of claim 1, further comprising:
receiving, via the user interface of the web-based platform from the user, a revision of a message generated and displayed by the AI chatbot on the user interface; and
updating the training of the ML model in view of the received revision of the message.

6. The method of claim 1, wherein the selection comprises an audience selection for the AI chatbot, wherein the audience selection is selected from any one or more of private to the user, the additional user, or any user on the web-based platform.

7. The method of claim 1, wherein the functions comprise any one or more of a language type, a tone of speech or a style of speech.

8. The method of claim 1, wherein the description of services of the AI chatbot comprises sharing information obtained on the Internet in a message to the user or the additional user on the web-based platform.

9. The method of claim 1, further comprising:
receiving, via the user interface of the web-based platform, a request from the user to delete or disable the created AI chatbot.

10. The method of claim 1, wherein the prompt comprises a tagline associated with the AI chatbot.

11. A method comprising:
receiving, via a user interface of a web-based platform configured with an artificial intelligence (AI) chatbot, a communication from a user or an additional user on the web-based platform;
reviewing, via the AI chatbot, the received communication from the user or the additional user, wherein the AI chatbot comprises a trained machine learning (ML) model trained on any one or more of a description of services or functions of the AI chatbot selected by the user or data associated with the user on the web-based platform;
generating, via the trained ML model of the AI chatbot, a message in response to the received communication; and
causing to display, via the user interface of the web-based platform, the generated message as a reply from the AI chatbot to the received communication.

12. The method of claim 11, wherein:
the AI chatbot is associated with an account of the user; and
the AI chatbot is configured to communicate with the additional user on behalf of the user.

13. The method of claim 11, further comprising:
receiving, via the user interface of the web-based platform from the user, a revision to the displayed message; and
updating the trained ML model based on the received revision.

14. The method of claim 11, wherein the data associated with the user is selected from any one or more of trends, posts or interests located on the web-based platform.

15. The method of claim 11, wherein the functions comprise any one or more of a language type, a tone of speech or a style of speech.

16. The method of claim 11, wherein the description of services of the AI chatbot comprises sharing information obtained on the Internet in a message to the user or the additional user on the web-based platform.

17. A system comprising:
one or more processors; and
at least one memory storing instructions, that when executed by the one or more processors, cause the system to:
cause to display, via a user interface of a web-based platform, a prompt to create an artificial intelligence (AI) chatbot, wherein the prompt comprises a description of services and functions associated with the AI chatbot;
receive, via the user interface from a user of the web-based platform, a selection of any one or more of the description of services or the functions associated with the AI chatbot;
train, based on the received input and data associated with the user available on the web-based platform, a machine learning (ML) model associated with the AI chatbot;
configure the created AI chatbot with the trained ML model; and
display, via the user interface of the web-based platform, the configured AI chatbot configured to communicate in real-time with the user or an additional user of the web-based platform.

18. The system of claim 17, wherein the data associated with the user is selected from any one or more of trends, posts or interests located on the web-based platform.

19. The system of claim 17, wherein when the one or more processors execute the instructions, the system is configured to:
receive, via the user interface of the web-based platform, from the user, a revision of a message generated and displayed by the AI chatbot on the user interface; and
update the training of the ML model based on the received revision of the message.

20. The system of claim 17, wherein:
the selection comprises an audience selection for the AI chatbot, wherein the audience selection is selected from any one or more of private to the user, the additional user, or any user on the web-based platform; or
the functions comprise any one or more of a language type, a tone of speech or a style of speech; or
the description of services of the AI chatbot comprises sharing information obtained on the Internet in a message to the user or the additional user on the web-based platform.
